(19) United States
(12) Patent Application Publication
(10) Pub. No.: US 2011/0100171 A1
(43) Pub. Date: May 5, 2011

(54) Starter strip for protective adhesive film or tape

(76) Inventors: Charles E. Mellno, SR., Providence, RI (US); Charles E. Mellno, JR., Cranston, RI (US)

(21) Appl. No.: 11/490,655

(22) Filed: Jul. 21, 2006

Related U.S. Application Data
(60) Provisional application No. 60/710,257, filed on Aug. 22, 2005.

(51) Int. Cl. B26B 29/06; B26D 7/00

(52) U.S. Cl. 83/13; 83/821

(57) ABSTRACT

A starter strip for protective adhesive film or tape for ease in starting and cutting a roll of protective adhesive film or tape. In one embodiment, the starter strip comprises a semi rigid plastic elongated body. The starter strip further comprises a cutting groove running along the length of the starter strip to provide a clean, straight cut of the adhesive tape or film when the roll is used without a dispenser or unintentional cutting into carpet, flooring or linoleum. The starter strip further comprises a cutting edge a that provides a clean, straight cut of the adhesive film when the roll is used with a dispenser. The starter strip further comprises a cutting edge b that provides a clean, straight cut of the adhesive film when the roll is used with a dispenser. The starter strip may further comprise a flatter side that can be laid against the sticky surface of the roll where it remains ready for the next use.

### RELATED APPLICATIONS

The present application is a continuation-in-part application of U.S. provisional patent application, Ser. No. 60-710,257, filed Aug. 22, 2005, for STARTER STRIP FOR PROTECTIVE ADHESIVE FILM OR TAPE, by Charles Melino, Sr. and Charles Melino, Jr., included by reference herein and for which benefit of the priority date is hereby claimed.

### FIELD OF THE INVENTION

The present invention relates to ease in using a roll of protective adhesive film or tape and, more particularly, to ease in starting and cutting said roll of protective adhesive film or tape.

### BACKGROUND OF THE INVENTION

In the industry which provides protective adhesive films or tapes, there exists for ease of application a product that is rolled with the sticky side facing out, or what is commonly referred to in the industry as “reverse wound”. Although reverse winding makes it easier to dispense the film onto carpeting and other horizontal surfaces, it becomes more difficult to get the roll started because the leading edge always sticks right back to the roll. Even folding over a tab at the end of the roll does not help because the tab itself just sticks right back to the roll. There is, therefore, a need for a semi rigid strip which will prohibit the leading edge of film from sticking back to the roll by being placed between the leading edge of the roll and the sticky outer surface of the roll itself. When the plastic strip is stuck to the end of a roll of adhesive film, the user can easily grasp and pull the leading edge of the roll of adhesive film together with the plastic strip. The plastic strip therefore provides an elongated semi-rigid handle which makes starting a reverse-wound adhesive film roll much more manageable. By sticking the starter strip to the adhesive film before cutting the film, the leading edge of the film is prevented from coming back in contact with the sticky outer surface of the roll, thereby making it easier to get stared on the next application. Our starter strip is also a straight edge which helps simplify cutting the film from the roll.

Although some manufacturers place colored adhesive tabs at the beginning of the roll to assist in identifying the beginning of the roll at initial start up, these tabs are not rigid or reusable, and assist the end user only in identifying the beginning of the roll and only upon initial use. These also do not assist the user at all in peeling the tape or film from the roll. Our starter strip not only identifies the beginning of the roll for initial use, but can be re-used time and again to not only identify the beginning of the roll for next use, but to also make it much easier to re-start the roll because the starter strip prevents the leading edge of the film from getting stuck back to the roll.

It is therefore an object of the invention to provide a means by which a roll of adhesive film or tape can be easily started, initially upon first use of the roll and additionally for each consecutive start of the roll, and aids in peeling the film when the roll is dispensed whether with or without a dispenser.

It is another object of the invention to serve as a cutting guide so that a straight line can be achieved at the end of each consecutive run of adhesive film. The cutting guide or edges also eliminate risk of damaging flooring or floor covering while cutting the film with a utility knife.

It is another object of the invention to allow the end user, after cutting the film, to leave the starter strip on the leading edge and secure the starter strip to the roll for ease in next use.

It is another object of the invention to be used within the automotive industry to provide an efficient way to get sheets of adhesive film from the dispenser to the automobiles the mechanics are working on.

### SUMMARY OF THE INVENTION

In accordance with the present invention, there is provided a starter strip for protective adhesive film or tape.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a starter strip for adhesive tape or film, which is a semi-rigid plastic strip for use in starting a roll of adhesive film, a cutting groove, and two straight edges, cutting edge a and cutting edge b;

FIG. 2 is a perspective view of a starter strip being used to locate the leading edge of the roll and easily pull the leading edge of the roll using the starter strip;

FIG. 3 is a perspective view of a person removing the starter strip from said roll of adhesive film;

FIG. 4 is a perspective view of a person without a dispenser sticking the starter strip in FIG. 1 onto the roll for the purpose of using the cutting groove as a guide for making a straight cut, and to then use the strip to start the roll with little effort at its next use;

FIG. 5 is a perspective view of a person with a dispenser sticking the plastic strip in FIG. 1 onto the roll for the purpose of using the cutting edge as a guide for making a straight cut, and to then use the strip to start the roll with little effort at its next use;

FIG. 6 is a perspective view of a person cutting the film from the roll when used without a dispenser;

FIG. 7 is a perspective view of a person cutting the film from the roll when used with a dispenser;

FIG. 8 is a perspective view of a person folding the plastic strip back against the roll to prepare said roll and plastic strip for next use; and

FIG. 9 is a perspective view of a plastic strip as it would be used in the automotive industry.

For purposes of clarity and brevity, like elements and components will bear the same designations and numbering throughout the Figures.

### DESCRIPTION OF THE PREFERRED EMBODIMENT

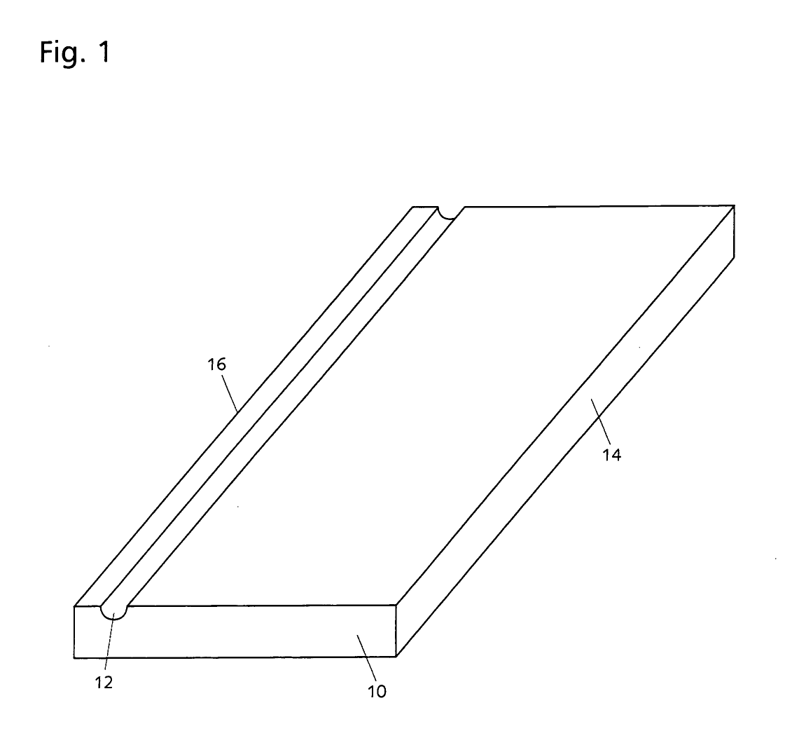

FIG. 1 is a perspective view of a Starter Strip 10, which is a semi-rigid plastic strip for use in starting a roll of adhesive film, a Cutting Groove 12, and two straight edges, Cutting Edge A 14 and Cutting Edge B 16. The Flat side of Starter Strip 18 is not visible in this figure.

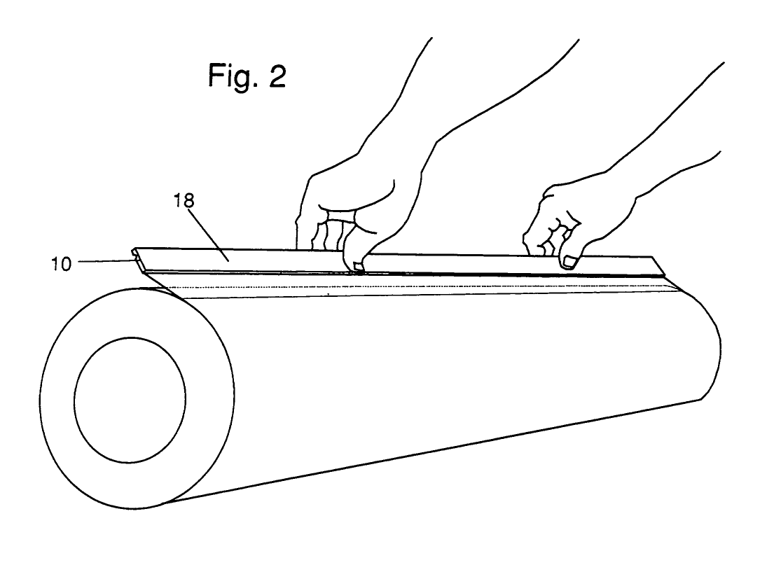

FIG. 2 is a perspective view of a person starting the roll of said adhesive tape or film by pulling the Starter Strip 10 in FIG. 1.

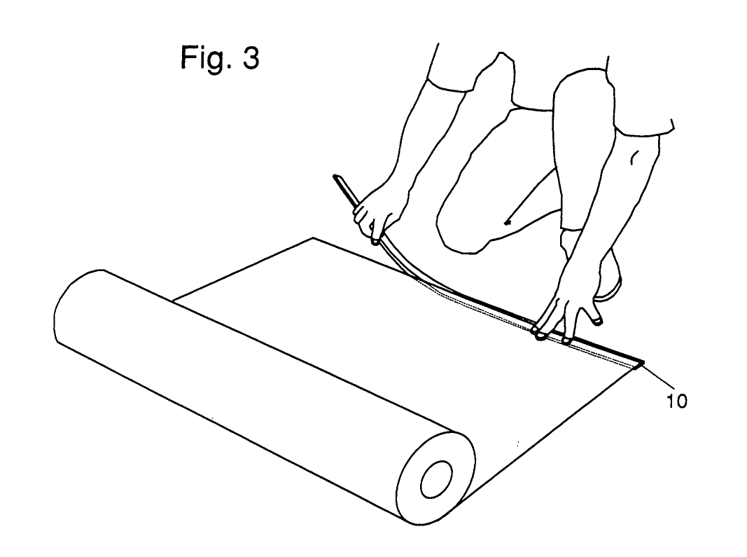

FIG. 3 is a perspective view of a person removing the Starter Strip 10 from said roll of adhesive tape or film.

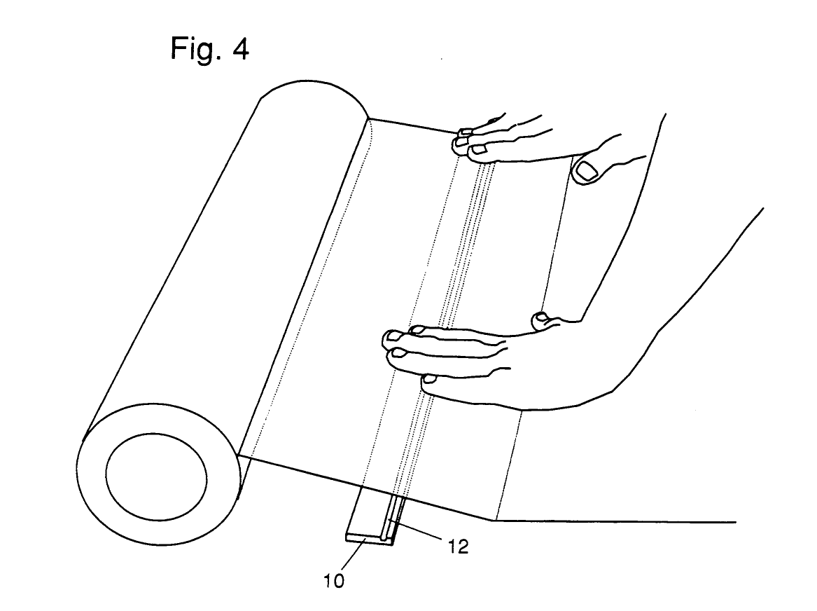

FIG. 4 is a perspective view of a person without a dispenser sticking the Starter Strip 10 in FIG. 1 onto the roll for the purpose of using the Cutting Groove 12 as a guide for making a straight cut, and to then use the strip to start the roll with little effort at its next use.

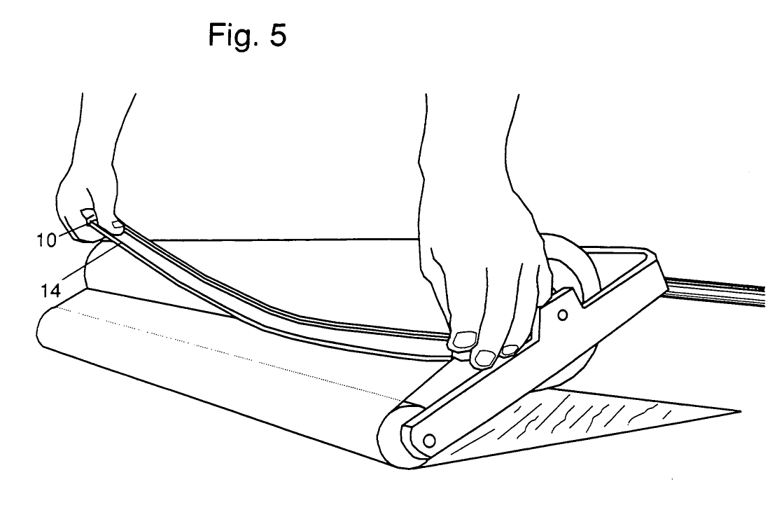

FIG. 5 is a perspective view of a person with a dispenser sticking the Starter Strip 10 in FIG. 1 onto the roll for the purpose of using the Cutting Edge A 14 as a guide for making a straight cut, and to then use the Starter Strip 10 to start the roll with little effort at its next use.

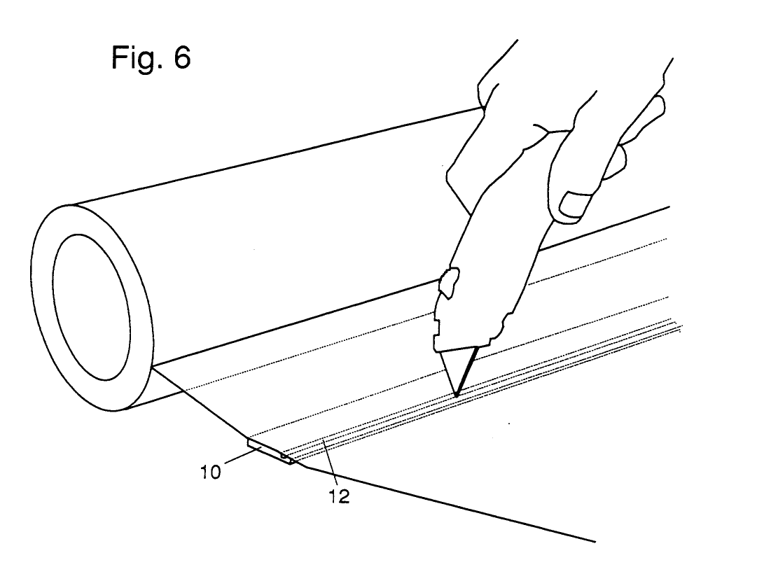

FIG. 6 is a perspective view of a person using the Cutting Groove 12 to cut the film from the roll when used without a dispenser.

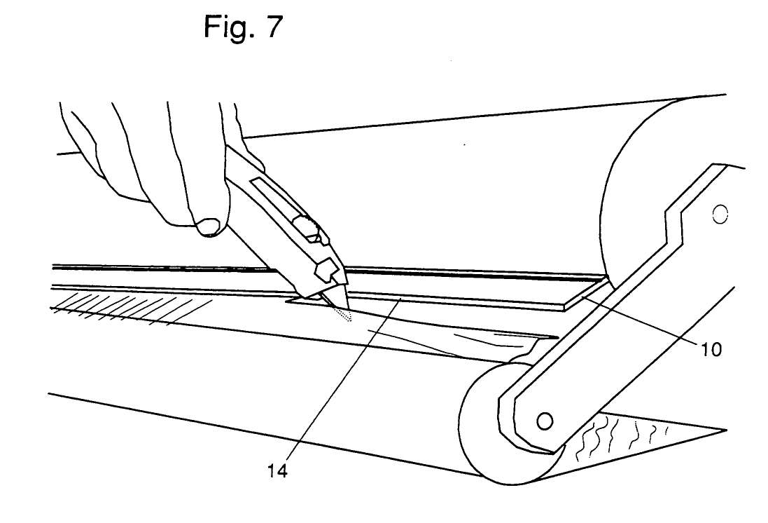

FIG. 7 is a perspective view of a person using the Cutting Edge A 14 or the

Cutting Edge B 16 to cut the film from the roll when used with a dispenser.

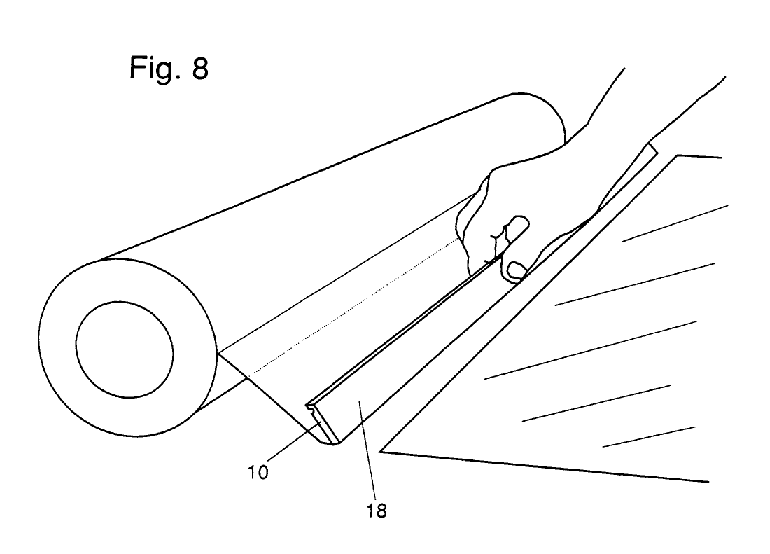

FIG. 8 is a perspective view of a person folding the Starter Strip 10 back against the roll to prepare said roll and Starter Strip 10 for next use.

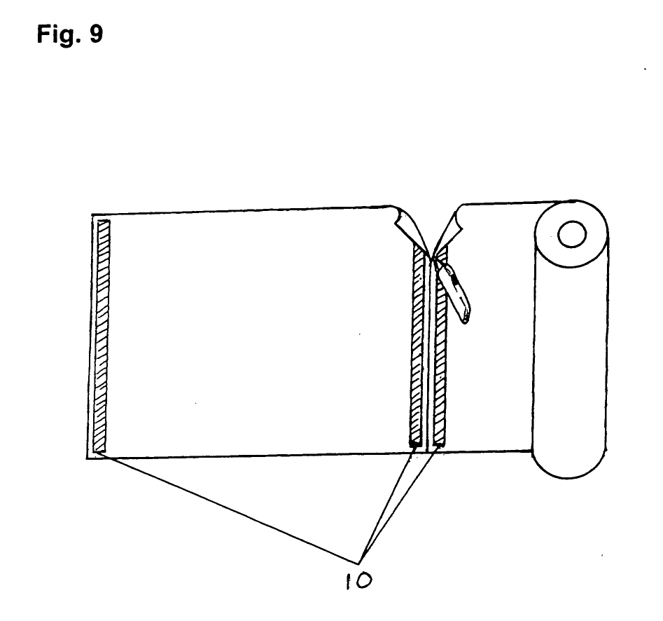

FIG. 9 is a perspective view of a Starter Strip 10 as it would be used in'the automotive industry.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. (canceled)

2. (canceled)

3. (canceled)

4. (canceled)

5. (canceled)

6. (canceled)

7. (canceled)

8. (canceled)

9. A device for use with a roll of protective film having a width, and first and second adhesive portions, the device comprising: an elongated body having front and rear portions, upper and lower surfaces, and first and second side portions; a cutting groove extending along said upper surface from said first end portion to said second end portion; first and second cutting edges disposed along said front and rear portions, respectively; said elongated body may be placed in contact with the first adhesive portion and said adhesive film may be cut using said cutting groove; said lower surface of said elongated body may be folded into contact with the second adhesive portion and the protective film may be cut using said first cutting edge.

10. The device of claim 9, wherein said cutting groove is substantially parallel to said first and second cutting edges.

11. The device of claim 10, wherein said elongated body has a width that is substantially equal to the width of the roll of adhesive film.

12. The device of claim 11, wherein said first and second cutting edges extend along said upper surface of said elongated body.

13. The device of claim 12, wherein said cutting groove is concave shaped.

14. The device of claim 13, wherein said elongated body is substantially rigid.

15. The device of claim 14, wherein said elongated body is made from plastic.

16. A process comprising the steps of:
(a) providing a roll of protective film having first and second adhesive portions;
(b) providing an elongated member having upper and lower surfaces and a first end portion; a cutting groove along said upper surface, and a first cutting edge along said first end portion;
(c) bringing said first adhesive portion of said protective film into contact with said upper surface of said elongated body member; and
(d) cutting said protective film along said cutting groove.

17. The process of claim 16, further comprising the step of (e) pulling said elongated body to unroll said protective film.

18. The process of claim 17, further comprising the step of: (f) folding said lower surface of said elongated body into contact with said second adhesive portion of protective film.

19. The process of claim 18, further comprising the step of (g) cutting said protective film along said first cutting edge.
